(19) United States
(12) Patent Application Publication
(10) Pub. No.: US 2026/0024896 A1
(43) Pub. Date: Jan. 22, 2026

(54) SECONDARY BATTERY

(71) Applicant: SAMSUNG SDI CO., LTD., Yongin-si (KR)

(72) Inventor: Taewoong JANG, Yongin-si (KR)

(21) Appl. No.: 18/967,847

(22) Filed: Dec. 4, 2024

(30) Foreign Application Priority Data
Jul. 22, 2024 (KR) 10-2024-0096660

(51) Int. Cl. H01M 50/586; H01M 10/04; H01M 50/533; H01M 50/595

(52) U.S. Cl. CPC H01M 50/586; H01M 10/0427; H01M 10/0431; H01M 50/533; H01M 50/595

(57) ABSTRACT

A secondary battery includes an electrode assembly including a wound structure of first electrode, a second electrode, and a separator disposed between the first electrode and the second electrode, the electrode assembly including a through-hole at a winding core of the wound structure, a case having an opening at one side thereof, the case accommodating the electrode assembly, a cap assembly that seals the opening of the case, and an insulating sheet between the cap assembly and the electrode assembly, the insulating sheet including a main sheet and a protrusion on the main sheet, and the protrusion being inserted into the through-hole of the electrode assembly.

### CROSS-REFERENCE TO RELATED APPLICATION

The present application claims priority to and the benefit of Korean Application No. 10-2024-0096660, filed on Jul. 22, 2024, in the Korean Intellectual Property Office, the entire disclosure of which is incorporated by reference herein.

### BACKGROUND

### 1. Field

Aspects of embodiments of the present disclosure relate to a secondary battery including an insulating sheet having a protrusion inserted into a through-hole of an electrode assembly.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

A secondary battery according to an embodiment of the present disclosure includes an electrode assembly configured by winding a first electrode, a second electrode, and a separator disposed between the first electrode and the second electrode, the electrode assembly including a through-hole at a winding core; a case having an opening at one side thereof and accommodating the electrode assembly that is inserted through the opening; a cap assembly that seals the opening of the case; and an insulating sheet disposed between the cap assembly and the electrode assembly. Further, the insulating sheet includes a main sheet and a protrusion formed on the main sheet, the protrusion being inserted into the through-hole of the electrode assembly.

According to an embodiment of the present disclosure, the first electrode may be connected to an electrode tab, and the insulating sheet may be disposed between the electrode tab and the electrode assembly.

According to an embodiment of the present disclosure, a diameter of the protrusion may be smaller than a diameter of the through-hole.

According to an embodiment of the present disclosure a vertical length of the protrusion may be smaller than a vertical length of the through-hole.

According to an embodiment of the present disclosure, the insulating sheet may include a central hole passing through the protrusion.

According to an embodiment of the present disclosure, the protrusion may be formed to slope toward a center of the protrusion.

According to an embodiment of the present disclosure, the insulating sheet may include a material having a porous structure.

According to an embodiment of the present disclosure, the secondary battery described above may further include an electrolyte to be contained in the case. Further, the electrolyte flows between inside and outside of the insulating sheet.

According to an embodiment of the present disclosure, the protrusion may be formed on a first surface of the insulating sheet, and the secondary battery described above may further include a cover sheet disposed on a second surface of the insulating sheet, the second surface being opposite to the first surface.

According to an embodiment of the present disclosure, the secondary battery described above may further include an electrolyte to be contained in the case. Further, the insulating sheet may include a material having a porous structure, and the cover sheet may include a material having a non-porous structure.

According to an embodiment of the present disclosure, the cover sheet may prevent evaporation of the electrolyte from the second surface of the insulating sheet.

According to an embodiment of the present disclosure, the cover sheet may entirely cover the second surface of the main sheet.

According to an embodiment of the present disclosure, the first electrode may be connected to an electrode tab, the insulating sheet may be disposed between the electrode tab and the electrode assembly, the cover sheet includes an insulating material, and at least one of the insulating sheet or the cover sheet provides insulation between the electrode assembly and the electrode tab or between the electrode assembly and the cap assembly.

According to an embodiment of the present disclosure, a diameter of the insulating sheet may be smaller than a diameter of the wound electrode assembly.

According to an embodiment of the present disclosure, a cover tape, which extends by a predetermined length from a region where the electrode tab and the electrode assembly are connected, may be attached to opposite surfaces of the electrode tab.

According to an embodiment of the present disclosure, a sum of the predetermined length and a radius of the main sheet may be greater than a radius of the electrode assembly.

According to an embodiment of the present disclosure, the electrode tab may be bent underneath the cap assembly in the case sealed by the cap assembly, and the cover tape attached to the bent electrode tab may come into contact with the insulating sheet.

According to an embodiment of the present disclosure, the insulating sheet may be fixed to the electrode assembly by inserting the protrusion into the through-hole.

According to an embodiment of the present disclosure, a vertical length of the protrusion may be equal to or greater than a radius length of the main sheet.

According to an embodiment of the present disclosure, a vertical length of the protrusion may be smaller than a diameter of the main sheet.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the attached drawings, in which:

FIG. 1 is a cross-sectional view of a secondary battery according to an embodiment of the present disclosure;

FIG. 2 is a perspective view of an insulating sheet according to an embodiment of the present disclosure;

FIG. 3 is a cross-sectional view of an insulating sheet according to an embodiment of the present disclosure;

FIG. 4 is a perspective view of an insulating sheet according to another embodiment of the present disclosure;

FIG. 5 is a cross-sectional view of the insulating sheet in FIG. 4;

FIG. 6 is a perspective view of an insulating sheet according to still another embodiment of the present disclosure;

FIG. 7 is a cross-sectional view of the insulating sheet according to FIG. 6;

FIG. 8 is a perspective view of an insulating sheet according to a yet another embodiment of the present disclosure;

FIG. 9 is a cross-sectional view of the insulating sheet in FIG. 8;

FIG. 10 is a perspective view of an insulating sheet according to still another embodiment of the present disclosure;

FIG. 11 is a cross-sectional view of the insulating sheet in FIG. 10;

FIG. 12 illustrates an example of an electrode assembly on which an insulating sheet is disposed according to an embodiment of the present disclosure; and

FIG. 13 is a cross-sectional view of a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

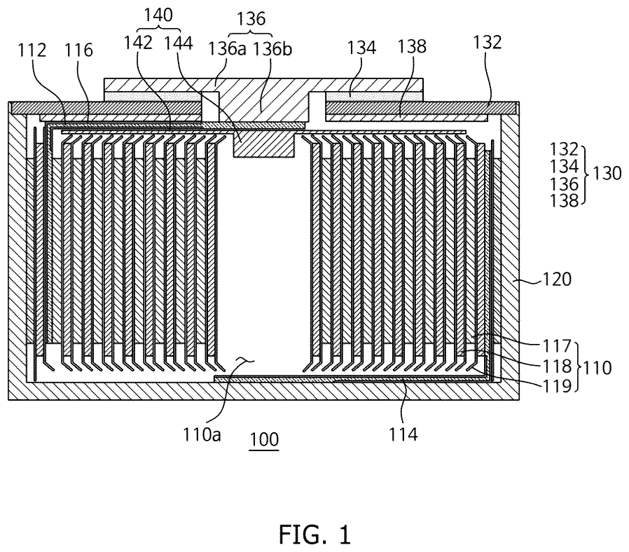

FIG. 1 is a cross-sectional view of a secondary battery 100 according to an embodiment of the present disclosure. FIG. 1 illustrates a cross-sectional view showing a structure in which the secondary battery 100 having a substantially cylindrical shape is cut in a height direction along a line passing through the center of the secondary battery 100. As shown in FIG. 1, the secondary battery may include an electrode assembly 110, a case 120, a cap assembly 130, and an insulating sheet 140.

The secondary battery 100 may be a coin-type secondary battery or a button-type secondary battery. For example, the secondary battery 100 may have a cylindrical shape. However, secondary battery 100 may have any suitable shape, e.g., a cylindrical shape, a prismatic shape, a pouch shape, or the like.

The electrode assembly 110 may include a first electrode 117, a second electrode 118, and a separator 119. For example, the electrode assembly 110 may be configured by winding the first electrode 117 and the second electrode 118 together with the separator 119 disposed between the first electrode 117 and the second electrode 118. The electrode assembly 110 may be wound to form a wound structure with a winding core and may include a through-hole 110a at the winding core.

The first electrode may include a first substrate and a first active material layer applied onto the first substrate. A first electrode tab 112 may extend outward from a first uncoated portion of the first substrate where the first active material layer is not applied, and the first electrode tab 112 may be electrically connected to a terminal plate 136 of the cap assembly 130.

The second electrode may include a second substrate and a second active material layer applied onto the second substrate. A second electrode tab 114 may extend outward from a second uncoated portion of the second substrate where the second active material layer is not applied, and the second electrode tab 114 may be electrically connected to the case 120. The first electrode tab 112 and the second electrode tab 114 may respectively extend in opposite directions from each other.

In an embodiment, each of the first electrode tab 112 and the second electrode tab 114 may be covered with a cover tape 116. The cover tape 116 may include an insulating material. The insulating material may provide electrical insulation to prevent current from passing therethrough. The cover tape 116 may prevent each of the first electrode tab 112 and the second electrode tab 114 from being short-circuited.

In an embodiment, the cover tape 116 may be attached to both surfaces (e.g., opposite surfaces) of each of the first electrode tab 112 and the second electrode tab 114. The cover tape 116 attached to the first electrode tab 112 may extend by a predetermined length from a region where the first electrode tab 112 and the electrode assembly 110 are connected. Similarly, the cover tape 116 attached to the second electrode tab 114 may extend by a predetermined length from a region where the second electrode tab 114 and the electrode assembly 110 are connected.

The first electrode may serve as a positive electrode. In this case, the first substrate may be composed of, e.g., an aluminum foil, and the first active material layer may include, e.g., a transition metal oxide. The second electrode may serve as a negative electrode. In this case, the second substrate may be composed of, e.g., a copper foil or a nickel foil, and the second active material layer may include, e.g., graphite.

The separator may serve to prevent a short circuit between the first electrode and the second electrode while allowing movement of lithium ions. The separator may be composed of, e.g., a polyethylene film, a polypropylene film, a polyethylene-polypropylene film, or the like.

For example, referring to FIG. 1, the first electrode tab 112 of the first electrode may be provided on one side of the electrode assembly 110, and the second electrode tab 114 of the second electrode may be provided on the other side of the electrode assembly 110. In another example, the first electrode tab 112 and the second electrode tab 114 may be provided on one (e.g., same) side of the electrode assembly 110.

The case 120 may accommodate the electrode assembly 110 and an electrolyte, and may form an overall outer appearance of the secondary battery together with the cap assembly 130. For example, the case 120 may include a substantially cylindrical sidewall portion and a bottom portion connected to one side of the sidewall portion. In another example, the case 120 may be configured in various shapes, e.g., a circular shape, a pouch shape, or the like. In addition, the case 120 may be composed of a metal, e.g., aluminum, an aluminum alloy, or a nickel-plated steel, or a laminated film or plastic used for a pouch.

The case 120 may accommodate the electrode assembly 110. The electrode assembly 110 may be inserted into the case 120 through an opening formed at one side of the case 120. The opening of the case 120 may then be closed (or sealed) by the cap assembly 130. The cap assembly 130 may be joined to one side of the case 120.

The cap assembly 130 may include a cap plate 132, an insulating layer 134, a terminal plate 136, and an insulating member 138. The cap plate 132 may seal the opening of the case 120. The cap plate 132 may be joined to a side surface of the case 120 corresponding to a side surface of the opening.

The cap plate 132 may have an insertion hole. For example, the insertion hole may be formed approximately at the center of the cap plate 132. The terminal plate 136 may be inserted into the insertion hole and joined to the cap plate 132. The terminal plate 136 may include a body portion 136a and an insertion portion 136b protruding from the body portion 136a. Here, the insertion portion 136b of the terminal plate 136 may be inserted into the insertion hole of the cap plate 132. Further, the insertion portion 136b of the terminal plate 136 may be connected to the first electrode tab 112 by contacting the first electrode tab 112. For example, as shown in FIG. 1, the cap assembly 130 including the terminal plate 136 may be coupled to the case 120 such that the insertion portion 136b faces the electrode assembly 110. However, in another example, the terminal plate 136 may be inserted into the insertion hole of the cap plate 132 such that the insertion portion 136b faces a direction opposite to the electrode assembly (i.e., toward a top surface of the secondary battery).

The insulating layer 134 may be disposed between the terminal plate 136 and the cap plate 132. The insulating layer 134 may have adhesive properties to thereby bond the terminal plate 136 and the cap plate 132 to each other. The insulating layer 134 may be formed of an insulating material to electrically insulate between the terminal plate 136 and the cap plate 132.

In an embodiment, the insulating member 138 may be disposed on a bottom surface of the cap plate 132. Here, a top surface of the cap plate 132 may face the body portion 136a of the terminal plate 136, and the bottom surface of the cap plate 132 may face the electrode assembly 110. The insulating member 138 may be made of an insulating material to provide electrical insulation between the cap plate 132 and the electrode assembly 110 or between the cap plate 132 and the first electrode tab 112.

The insulating sheet 140 may be disposed between the cap assembly 130 and the electrode assembly 110. For example, the insulating sheet 140 may be disposed between the first electrode tab 112 and the electrode assembly 110. The insulating sheet 140 may include an insulating material, thereby preventing a short circuit between the cap assembly 130 and the electrode assembly 110. Further, the insulating sheet 140 may prevent a short circuit between the first electrode tab 112 and the electrode assembly 110.

The insulating sheet 140 may include a main sheet 142 and a protrusion 144, which is formed on the main sheet 142 and inserted into the through-hole 110a of the electrode assembly 110. For example, as illustrated in FIG. 1, the protrusion 144 and the main sheet 142 may be integral with each other (e.g., formed in a same process and of a same material into a single, monolithic, and seamless structure). The main sheet 142 may be disposed between the first electrode tab 112 and the electrode assembly 110 (e.g., the main sheet 142 may be between the cap assembly 130 and the electrode assembly 110). For example, the protrusion 144 may be formed on (e.g., directly on) a bottom surface of the main sheet 142. Here, a top surface of the electrode assembly 110 may be a surface of the electrode assembly 110 that faces the cap assembly 130. The bottom surface of the main sheet 142 may face the top surface of the electrode assembly 110. A top surface of the main sheet 142 may face the cap assembly 130. The top surface of the main sheet 142 may contact (e.g., directly contact) the first electrode tab 112.

In an embodiment, a diameter of the insulating sheet 140 may be smaller than a diameter of the electrode assembly 110. For example, a diameter of the main sheet 142 may be smaller than the diameter of the electrode assembly 110. As a result, the main sheet 142 may cover at least a portion of the top surface of the electrode assembly 110, e.g., the top surface of the electrode assembly 110 may extend beyond the edge of the main sheet 142 in a horizontal direction that is parallel to the bottom of the electrode assembly 110.

In an embodiment, a diameter of the protrusion 144 may be smaller (e.g., only slightly or negligibly smaller) than a diameter of the through-hole 110a of the electrode assembly 110 (e.g., only sufficiently smaller to allow insertion of the protrusion 144 into the through-hole 110a). Further, a length of the protrusion 144 in a vertical direction may be smaller than a length of the through-hole 110a in the vertical direction. Here, the vertical direction may refer to the height direction of the secondary battery (e.g., the vertical direction may be a direction perpendicular or normal with respect to the bottom of the electrode assembly 110).

In an embodiment, the diameter of the protrusion 144 may be substantially similar to the diameter of the through-hole of the electrode assembly 110. That is, when the protrusion 144 is inserted into the through-hole of the electrode assembly 110, the protrusion 144 may be tightly fitted in the through-hole, e.g., an outer sidewall of the protrusion 144 may be in direct contact with at least a portion of an inner sidewall of the through-hole 110a of the electrode assembly 110. Since there is substantially no space between the protrusion 144 and an inner surface of the electrode assembly 110, the movement of the protrusion 144 within the through-hole 110a may be prevented or substantially minimized. As the protrusion 144 is secured within the through-hole 110a, the insulating sheet 140 may also be fixed in place.

With the aforementioned configuration, the insulating sheet 140 can be secured on the top surface of the electrode assembly 110 by inserting the protrusion 144 into the through-hole 110a of the electrode assembly 110. Thus, the insulating sheet 140 may not move or may have substantially minimized movement on the top surface of the electrode assembly 110. Accordingly, even if the secondary battery 100 according to an embodiment of the present disclosure is subjected to a drop or similar impact, the insulating sheet 140 may not be damaged.

Furthermore, when placing the insulating sheet 140 on the top surface of the electrode assembly 110, the protrusion 144 may be positioned to correspond with (e.g., overlap) the through-hole 110a of the electrode assembly 110. This makes it easier to align the center of the insulating sheet 140 with the center of the electrode assembly 110.

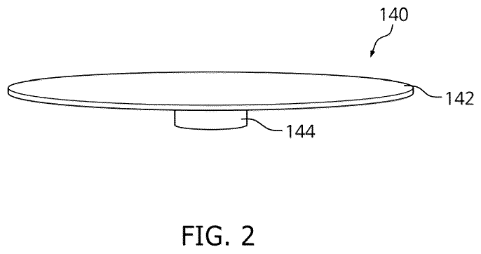

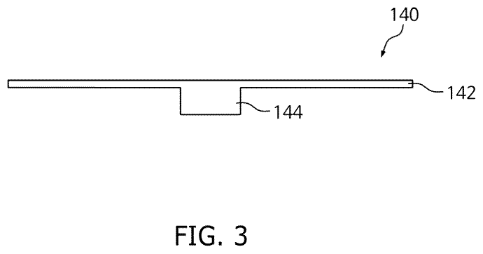

FIG. 2 is a perspective enlarged view of the insulating sheet 140 according to an embodiment of the present disclosure, and FIG. 3 is a cross-sectional view of the insulating sheet 140. FIG. 3 shows a cross-sectional view of a structure in which the insulating sheet 140 having a substantially circular shape is cut in a height direction along a line passing through the center of the insulating sheet 140.

Referring to FIGS. 2-3, the insulating sheet 140 may include the main sheet 142 and the protrusion 144 that is formed on the main sheet 142 and inserted into the through-hole of the electrode assembly. For example, the center of the protrusion 144 may be aligned with the center of the main sheet 142. Further, the protrusion 144 may be formed on a bottom surface of the main sheet 142. Here, the bottom surface of the main sheet 142 faces a top surface of the electrode assembly. For example, as illustrated in FIGS. 2-3, the main sheet 142 may be a continuous and flat sheet with a linear cross-section, and the main sheet 142 may completely cover the top of the protrusion 144, such that the main sheet 142 with the protrusion 144 may define a T-shaped cross-section.

As shown in FIG. 2, the main sheet 142 may have a substantially circular shape, and the protrusion 144 may have a substantially cylindrical shape. A diameter of the protrusion 144 in the horizontal direction may be smaller than a diameter of the main sheet 142 in the horizontal direction. A height of the protrusion 144 in the vertical direction may be smaller than the diameter of the main sheet 142 in the horizontal direction (e.g., a height of the protrusion 144 in the vertical direction may be larger than a thickness of the main sheet 142 in the vertical direction). However, the shapes, sizes, and other characteristics of the main sheet 142 and the protrusion 144 may be modified, e.g., a pattern may be formed on an outer surface of the protrusion 144 to facilitate the flow of electrolyte.

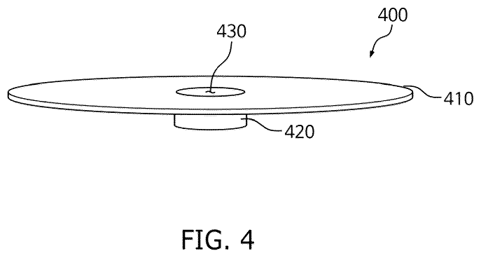

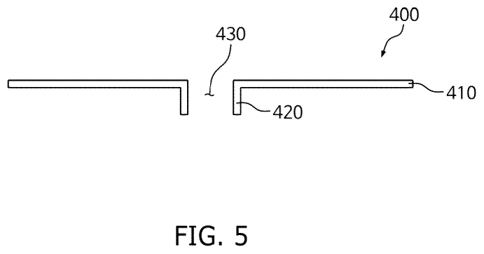

FIG. 4 is a perspective view of an insulating sheet 400 according to another embodiment of the present disclosure, and FIG. 5 is a cross-sectional view of the insulating sheet 400. FIG. 5 shows a cross-sectional view of a structure in which the insulating sheet 400 having a substantially circular shape is cut in a height direction along a line passing through the center of the insulating sheet 400.

Referring to FIGS. 4-5, the insulating sheet 400 may include a main sheet 410 and a protrusion 420 that is formed on the main sheet 410 and inserted into the through-hole of the electrode assembly. For example, the center of the protrusion 420 may be aligned with the center of the main sheet 410. Further, the protrusion 420 may be formed on a bottom surface of the main sheet 410. Here, the bottom surface of the main sheet 410 may face a top surface of the electrode assembly.

In an embodiment, the insulating sheet 400 may include a central hole 430 passing through the protrusion 420, e.g., the central hole 430 may extend through the entire height of the protrusion 420. A diameter of the central hole 430 may be smaller than a diameter of the protrusion 420. The protrusion 420 may extend in the vertical direction of the main sheet 410, and the central hole 430 may be formed parallel to an outer surface of the protrusion 420. Accordingly, an inner surface of the protrusion 420 corresponding to the central hole 430 may be parallel to the outer surface of the protrusion 420.

With the aforementioned configuration, the electrolyte may flow through the central hole 430. The electrolyte may be injected into the electrode assembly or the like through the central hole 430. Furthermore, by flowing through the central hole 430, the electrolyte may spread throughout the entire interior of the secondary battery.

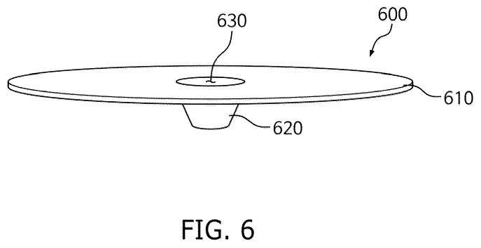

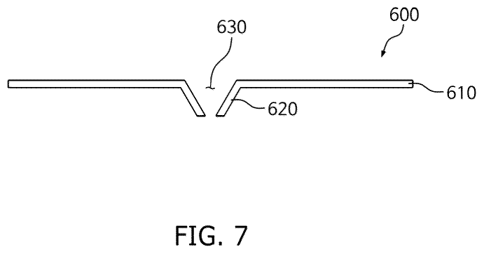

FIG. 6 is a perspective view of an insulating sheet 600 according to still another embodiment of the present disclosure, and FIG. 7 is a cross-sectional view of the insulating sheet 600. FIG. 7 shows a cross-sectional view of a structure in which the insulating sheet 600 having a substantially circular shape is cut in a height direction along a line passing through the center of the insulating sheet 600.

Referring to FIGS. 6-7, the insulating sheet 600 may include a main sheet 610 and a protrusion 620 that is formed on the main sheet 610 and inserted into the through-hole of the electrode assembly. For example, the center of the protrusion 620 may be aligned with the center of the main sheet 610. Further, the protrusion 620 may be formed on a bottom surface of the main sheet 610. Here, the bottom surface of the main sheet 610 may face a top surface of the electrode assembly.

In an embodiment, the insulating sheet 600 may include a central hole 630 passing through the protrusion 620. The protrusion 620 may be sloped toward the center of the protrusion 620 (i.e., the protrusion 620 may be tapered or inclined at an oblique angle in a downward direction). Additionally, the protrusion 620 may be formed to have a sidewall that slopes toward the center of the central hole 630. Referring to FIG. 7, the central hole 630 may be formed parallel to an outer surface of the protrusion 620. However, the shape of the central hole 630 may be modified, e.g., the central hole 630 may be formed parallel to the vertical direction of the main sheet 610.

With the aforementioned configuration, the flow of the electrolyte from the top surface to the bottom surface of the insulating sheet 600 may be relatively smoother compared to the flow of the electrolyte from the bottom surface to the top surface of the insulating sheet 600. As a result, the injection and flow of the electrolyte toward the electrode assembly can be more efficient.

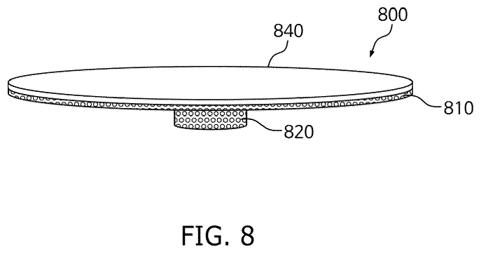

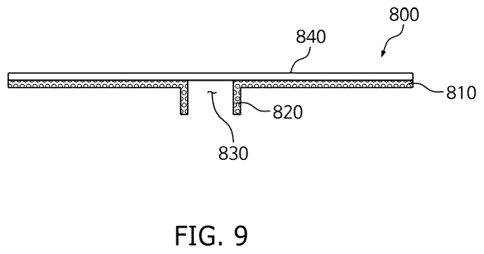

FIG. 8 is a perspective view of an insulating sheet 800 according to yet another embodiment of the present disclosure, and FIG. 9 is a cross-sectional view of the insulating sheet 800. FIG. 9 shows a cross-sectional view of a structure in which the insulating sheet 800 having a substantially circular shape is cut in a height direction along a line passing through the center of the insulating sheet 800.

Referring to FIGS. 8-9, the insulating sheet 800 may include a main sheet 810 and a protrusion 820 that is formed on the main sheet 810 and inserted into the through-hole of the electrode assembly. For example, the center of the protrusion 820 may be aligned with the center of the main sheet 810. Further, the protrusion 820 may be formed on a bottom surface of the main sheet 810. Here, the bottom surface of the main sheet 810 may face a top surface of the electrode assembly.

In an embodiment, the insulating sheet 800 may include a central hole 830 passing through the protrusion 820. A diameter of the central hole 830 may be smaller than a diameter of the protrusion 820. The protrusion 820 may extend in the vertical direction of the main sheet 810, and the central hole 830 may be formed parallel to an outer surface of the protrusion 820. Accordingly, an inner surface of the protrusion 820 corresponding to the central hole 830 may be parallel to the outer surface of the protrusion 820.

In an embodiment, the insulating sheet 800 may include a material with a porous structure. For example, the insulating sheet 800 may include a plastic, e.g., polyethylene, polypropylene, or the like. The plastic may be processed to have the porous structure through, e.g., mechanical stretching, heat treatment, or the like. In other words, by including the material with the porous structure, the insulating sheet 800 allows the electrolyte to flow between the inside of the insulating sheet 800 and the outside of the insulating sheet 800.

With the aforementioned configuration, in a secondary battery containing the electrolyte and the insulating sheet 800, the electrolyte may flow between the inside of the insulating sheet 800 and the outside of the insulating sheet 800, e.g., to flow and be insertable into the case through the insulating sheet 800. In other words, even with the presence of the insulating sheet 800, the electrolyte may move freely within the secondary battery.

In an embodiment, the protrusion 820 may be formed on a bottom surface of the insulating sheet 800, and a cover sheet 840 may be disposed on a top surface of the insulating sheet 800. The cover sheet may include a material having a non-porous structure. In other words, the cover sheet may be formed of a material different from that of the insulating sheet 800. The cover sheet may include an insulating material. For example, the cover sheet may include a plastic that does not have a porous structure.

In an embodiment, the cover sheet may cover the entire top surface of the main sheet 810. For example, a diameter of the cover sheet may be equal to or greater than a diameter of the main sheet 810.

In an embodiment, the insulating sheet 800 and the cover sheet disposed on the top surface of the insulating sheet 800 may be inserted together into the through-hole of the electrode assembly. The insulating sheet 800 and the cover sheet may be placed between the electrode tab connected to the first electrode and the electrode assembly. In this case, at least one of the insulating sheet or the cover sheet may provide insulation between the electrode assembly and the electrode tab, or between the electrode assembly and the cap assembly.

In a secondary battery, after the electrode assembly is accommodated in the case, the electrolyte is injected and the insulating sheet 800 may be inserted. For example, the protrusion 820 of the insulating sheet 800 may be inserted into the through-hole of the electrode assembly. After the electrolyte is injected and the insulating sheet 800 is inserted, the case may be sealed by coupling the cap assembly with the case. Before the cap assembly is coupled with the case, the insulating sheet 800 and the electrolyte may be exposed through the opening of the case. Due to the porous structure of the insulating sheet 800 and the central hole 830, the exposure of the electrolyte to the outside may cause the electrolyte to evaporate. In this case, by disposing the cover sheet 840 on the top surface of the insulating sheet 800 (after injecting the electrolyte through the insulating sheet 800), the cover sheet 840 may cover the entire top surface of the insulating sheet, and the cover sheet may prevent the evaporation of the electrolyte exposed through the porous structure and the central hole 830 of the insulating sheet 800. As a result, it may not be necessary to additionally inject electrolyte into the secondary battery.

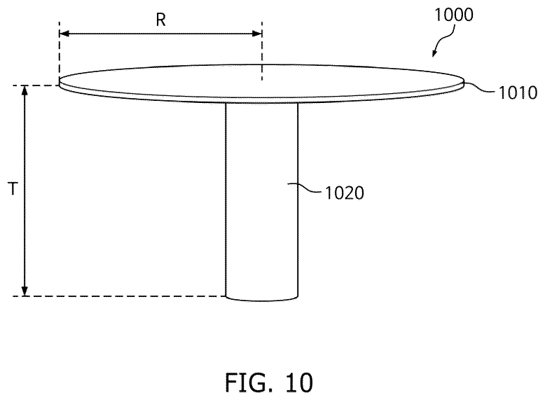

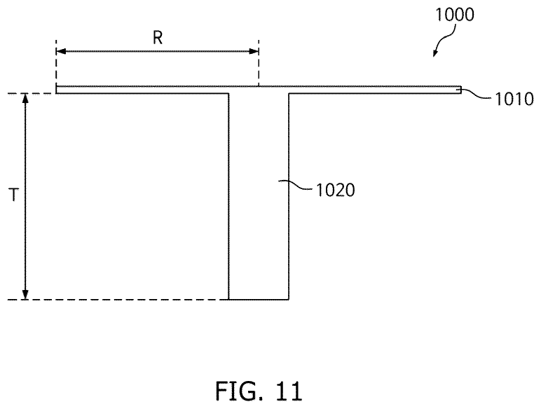

FIG. 10 is a perspective view of an insulating sheet 1000 according to still another embodiment of the present disclosure, and FIG. 11 is a cross-sectional view of the insulating sheet 1000. FIG. 11 shows a cross-sectional view of a structure in which the insulating sheet 1000 having a substantially circular shape is cut in a height direction along a line passing through the center of the insulating sheet 1000.

Referring to FIGS. 10-11, the insulating sheet 1000 may include a main sheet 1010 and a protrusion 1020 that is formed on the main sheet 1010 and inserted into the through-hole of the electrode assembly. For example, the center of the protrusion 1020 may be aligned with the center of the main sheet 1010. Further, the protrusion 1020 may be formed on a bottom surface of the main sheet 1010. Here, the bottom surface of the main sheet 1010 may face a top surface of the electrode assembly.

A length T of the protrusion 1020 in the vertical direction may be equal to or greater than the radius R of the main sheet 1010. Here, the vertical direction refers to a direction perpendicular to the plane of the main sheet 1010. The length T of the protrusion 1020 in the vertical direction may be smaller than a diameter of the main sheet 1010.

For example, the insulating sheet 1000 may include a central hole passing through the protrusion 1020, and a length of the central hole in the vertical direction may correspond to the length T of the protrusion 1020 in the vertical direction.

With the aforementioned configuration, a predetermined length of the protrusion 1020 may be secured. In a case where the protrusion 1020 having the predetermined length is inserted into the through-hole of the electrode assembly, the insulating sheet 1000 may be relatively firmly fixed. In other words, even in a case where a relatively large external force is applied to the insulating sheet 1000, the movement and shifting of the insulating sheet 1000 is less likely to occur.

In a comparative example, if an insulating sheet were not to have a protrusion on its bottom surface (i.e., if the insulating sheet were to be completely flat on both top and bottom surfaces thereof), the insulating sheet would have moved on the top surface of the electrode assembly. This movement may result in the center of the insulating sheet not aligning with the center of the electrode assembly. Additionally, as the insulating sheet shifts and moves on the top surface of the electrode assembly, an electrode tab bent toward the insulating sheet may come into direct contact with the electrode assembly, thereby causing a short circuit between the electrode tab and the electrode assembly.

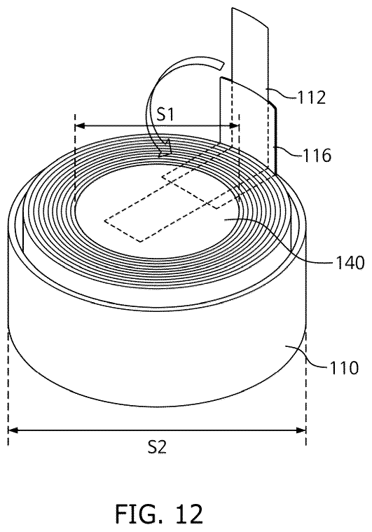

In contrast, referring to FIGS. 1 and 12, the insulating sheet 140, according to example embodiments, may include the main sheet 142 and the protrusion 144 formed on the main sheet 142. The protrusion 144 may be inserted into the through-hole 110a of the electrode assembly 110, and therefore, the insulating sheet 140 may be secured to the electrode assembly 110.

In an embodiment, a diameter S1 of the insulating sheet 140 (i.e., of the main sheet) may be smaller than a diameter S2 of the electrode assembly 110, so the insulating sheet 140 may cover a portion (e.g., only a portion) of the top surface of the electrode assembly 110. By forming the diameter S1 of the main sheet to be smaller than that of the electrode assembly 110, the manufacturing cost of the insulating sheet 140 may be reduced.

Referring to FIG. 12, after the insulating sheet 140 is disposed on the electrode assembly 110, the first electrode tab 112 may be bent toward the insulating sheet 140. At this time, there may be a risk that an area of the first electrode tab 112 to which the cover tape 116 is not attached may come into contact with a portion of the top surface of the electrode assembly 110. However, the insulating sheet 140 covers a portion of the top surface of the electrode assembly 110, and the protrusion is inserted into the through-hole to allow the insulating sheet 140 to be fixed to the electrode assembly 110. Therefore, a short circuit between the first electrode tab 112 and the electrode assembly 110 can be prevented. In other words, even with the main sheet having the diameter S1 which is smaller than that of the electrode assembly 110, the insulating sheet 140 still can cover a portion of the top surface of the electrode assembly, and the cover tape 116 can protect a portion of the first electrode tab 112. Therefore, the short circuit may not occur between the first electrode tab 112 and the electrode assembly 110. Details regarding the length of the cover tape 116 and the size of the main sheet of the insulating sheet to prevent the short circuit between the first electrode tab 112 and the electrode assembly 110 will be described with reference to FIG. 14.

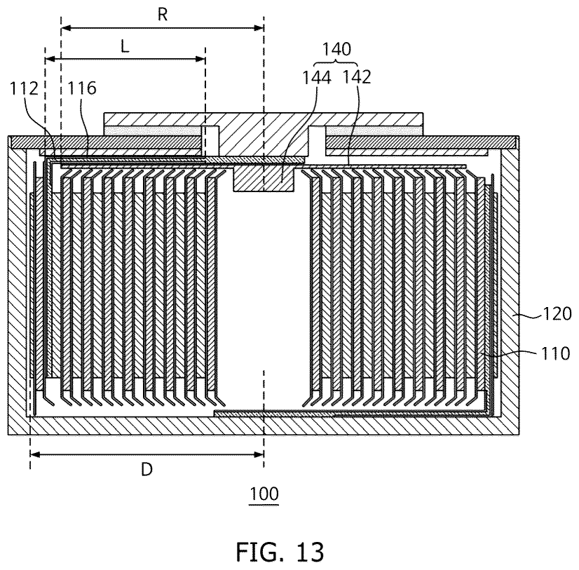

FIG. 13 is a cross-sectional view of the secondary battery 100 according to an embodiment of the present disclosure. In FIG. 13, the description will be focus on the radius of the main sheet 142 of the insulating sheet 140 and the length of the cover tape 116.

Referring to FIG. 13, the cover tape 116 may be attached to at least one surface of the first electrode tab 112. For example, the cover tape 116 may be attached to both surfaces (e.g., opposite surfaces) of the first electrode tab 112. The cover tape 116 may extend by a predetermined length L from a region where the first electrode tab 112 is connected to the electrode assembly 110. Here, the sum of the predetermined length L and the radius R of the main sheet may be greater than the radius D of the electrode assembly. The first electrode tab 112 may be bent underneath the cap assembly in the case 120 that is sealed by the cap assembly. Even in a case where the first electrode tab 112 is bent toward the electrode assembly 110, a portion of the first electrode tab 112 where the cover tape 116 is not attached may not be in contact with the electrode assembly 110 because the insulating sheet 140 is provided. The combination of the insulating sheet 140 and the cover tape 116 may prevent a short circuit from occurring between the first electrode tab 112 and the electrode assembly 110.

By way of summation and review, in a secondary battery, when two materials with different electrodes come into electrical contact, an internal short circuit may occur, rapidly increasing a temperature of the secondary battery, which in severe cases, may lead to a fire. To prevent such electrical contact between the materials with different electrodes in the secondary battery, insulating components may be provided in the secondary battery. However, if the secondary battery is subjected to impacts such as drops, the insulating components in the secondary battery may move or may be damaged due to the impact. Additionally, if the positions of these insulating components change, they may fail to adequately protect the intended targets, potentially causing a short circuit.

In view of the above, embodiments of the present disclosure provide a secondary battery with an insulating sheet having a protrusion inserted into the electrode assembly. As such, the insulating sheet may be secured to the electrode assembly, thereby preventing or substantial minimizing movement and exposure of parts of the electrode assembly to other electrodes.

According to various embodiments of the present disclosure, the protrusion of the insulating sheet is inserted into the through-hole of the electrode assembly, thereby securing the insulating sheet on the top surface of the electrode assembly. Additionally, the insulating sheet does not move or has minimized movement on the top surface of the electrode assembly. As a result, the secondary battery according to an embodiment of the present disclosure is less likely to have its insulating sheet damaged eve if subjected to impacts such as drops.

According to various embodiments of the present disclosure, when placing the insulating sheet on the top surface of the electrode assembly, the protrusions can be positioned to correspond to the through-hole of the electrode assembly. This arrangement makes it easier to align the center of the insulating sheet with the center of the electrode assembly.

According to various embodiments of the present disclosure, the electrolyte can flow through the central hole. In other words, the electrolyte can be injected into the electrode assembly and other components through the central hole. Furthermore, the movement of the electrolyte through the central hole allows the electrolyte to spread throughout the entire interior of the secondary battery.

According to various embodiments of the present disclosure, the flow of the electrolyte from the top surface toward the bottom surface of the insulating sheet may be relatively smoother compared to the flow from the bottom surface toward the top surface of the insulating sheet. As a result, the injection and flow of the electrolyte towards the electrode assembly can be facilitated more efficiently.

According to various embodiments of the present disclosure, by placing the cover sheet on the top surface of the insulating sheet, the cover sheet can cover the entire top surface of the insulating sheet. This cover sheet can prevent the evaporation of the electrolyte that is exposed through the porous structure and the central hole of the insulating sheet. Consequently, there may be no need to further inject the electrolyte into the secondary battery.

According to various embodiments of the present disclosure, in a case where the protrusion having a predetermined length is inserted into the through-hole of the electrode assembly, the insulating sheet can be relatively firmly secured. In other words, even in a case where a relatively large external force is applied to the insulating sheet, the insulating sheet may not move.

According to various embodiments of the present disclosure, by reducing the diameter of the main sheet of the insulating sheet, the manufacturing cost of the insulating sheet can be reduced.

According to various embodiments of the present disclosure, even with a reduced diameter of the main sheet, the insulating sheet can still cover a portion of the top surface of the electrode assembly. Further, the cover tape can protect a portion of the electrode tab connected to the first electrode. Therefore, the risk of short circuits between the electrode tab and the electrode assembly can be avoided.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a wound structure of a first electrode, a second electrode, and a separator disposed between the first electrode and the second electrode, the electrode assembly including a through-hole at a winding core of the wound structure;
a case having an opening at one side thereof, the case accommodating the electrode assembly;
a cap assembly that seals the opening of the case; and
an insulating sheet between the cap assembly and the electrode assembly, the insulating sheet including a main sheet and a protrusion on the main sheet, and the protrusion being inserted into the through-hole of the electrode assembly.

2. The secondary battery as claimed in claim 1, wherein the first electrode is connected to an electrode tab, and the insulating sheet is between the electrode tab and the electrode assembly.

3. The secondary battery as claimed in claim 2, further comprising a cover tape on opposite surfaces of the electrode tab, the cover tape extending by a predetermined length from a region where the electrode tab and the electrode assembly are connected.

4. The secondary battery as claimed in claim 3, wherein a sum of the predetermined length and a radius of the main sheet is greater than a radius of the electrode assembly.

5. The secondary battery as claimed in claim 3, wherein the electrode tab is bent underneath the cap assembly in the case sealed by the cap assembly, the cover tape being in contact with the insulating sheet.

6. The secondary battery as claimed in claim 1, wherein a diameter of the protrusion is smaller than a diameter of the through-hole.

7. The secondary battery as claimed in claim 1, wherein a vertical length of the protrusion is smaller than a vertical length of the through-hole.

8. The secondary battery as claimed in claim 1, wherein the insulating sheet includes a central hole through the protrusion.

9. The secondary battery as claimed in claim 1, wherein a sidewall of the protrusion is sloped toward a center of the protrusion.

10. The secondary battery as claimed in claim 1, wherein the insulating sheet includes a material having a porous structure.

11. The secondary battery as claimed in claim 7, further comprising an electrolyte in the case, the electrolyte being insertable into the case through the insulating sheet.

12. The secondary battery as claimed in claim 1, wherein:
the protrusion is on a first surface of the insulating sheet, and
the secondary battery further includes a cover sheet on a second surface of the insulating sheet, the second surface being opposite to the first surface.

13. The secondary battery as claimed in claim 12, wherein:
the secondary battery further includes an electrolyte in the case,
the insulating sheet includes a material having a porous structure, the electrolyte being insertable into the case through the insulating sheet, and
the cover sheet includes a material having a non-porous structure.

14. The secondary battery as claimed in claim 13, wherein the cover sheet is configured to prevent evaporation of the electrolyte from the second surface of the insulating sheet.

15. The secondary battery as claimed in claim 12, wherein the cover sheet entirely covers the second surface of the main sheet.

16. The secondary battery as claimed in claim 12, wherein:
the first electrode is connected to an electrode tab,
the insulating sheet is between the electrode tab and the electrode assembly,
the cover sheet includes an insulating material, and
at least one of the insulating sheet or the cover sheet provides insulation between the electrode assembly and the electrode tab or between the electrode assembly and the cap assembly.

17. The secondary battery as claimed in claim 1, wherein a diameter of the insulating sheet is smaller than a diameter of the electrode assembly.

18. The secondary battery as claimed in claim 1, wherein the insulating sheet is fixed to the electrode assembly by inserting into the through-hole.

19. The secondary battery as claimed in claim 1, wherein a vertical length of the protrusion is equal to or greater than a radius of the main sheet.

20. The secondary battery as claimed in claim 1, wherein a vertical length of the protrusion is smaller than a diameter of the main sheet.
